(19) United States
(12) Patent Application Publication
(10) Pub. No.: US 2009/0165071 A1
(43) Pub. Date: Jun. 25, 2009

(54) SYSTEM AND METHOD FOR REDUCING AUDIO VIDEO BANDWIDTH IN A HOME NETWORK

(75) Inventor: Stephane Lejeune, San Diego, CA (US)

Correspondence Address: ROGITZ & ASSOCIATES, 750 B STREET, SUITE 3120, SAN DIEGO, CA, 92101, US

(73) Assignees: Sony Corporation; Sony Electronics Inc.

(21) Appl. No.: 11/959,676

(22) Filed: Dec. 19, 2007

(51) Int. Cl. H04N 7/173

(52) U.S. Cl. 725/127; 370/535

(57) ABSTRACT

In a home network, instead of filtering out non-demanded digital programs on programs of a main digital transport stream after decryption by a conditional access (CA) device, the audio video data of all non-demanded digital programs is removed prior to decryption, to conserve bandwidth in the home network, while all non-audio video data remains in the stream for use as required by the CA device.

### I. FIELD OF THE INVENTION

The present invention relates generally to the transmission of audio video data in a home network.

### II. BACKGROUND OF THE INVENTION

Part of the Conditional Access (CA) mechanism used by Multichannel Video Programming Distributors (MVPD) consist in scrambling the programs being distributed when transiting over their communication network. In order to enable retail availability of receiver devices the MVPD's proprietary conditional access system has been separated from the receiver device and put in a CA module. The CA module provides secure access to descrambled programming.

Specifications have been defined for the interface between the CA module and the receiver device. One part of this interface consists of a Transport Stream interface carrying data received through the tuner/demodulator to the CA module. This data is organized in MPEG-2 Transport Packets. If the packet is scrambled and belongs to the selected program it is descrambled and received back from the module providing access to the service is granted. The same applies if the packet is scrambled at the at Packetized Elementary Stream (PES) level.

The MPEG-2 Transport Stream sent over to the CA module consists of the whole MPEG-2 multiplex. This means that the packets sent over can belong to the selected program but can also belong to another program that is not currently selected but nonetheless carried in the same Transport Stream multiplex. The requirement for sending the whole transport multiplex over to the CA module comes from the proprietary character of the CA system that relies on secret messages being buried within transport packets carried within this Transport Stream multiplex.

Because MVPD are very sensitive to protection of the content they distribute and in order to allow a program to be viewed through a home network it is desirable to keep the Conditional Access in place throughout the home network and to descramble the program only after traveling through the home network.

### SUMMARY OF THE INVENTION

The present invention describes a way to keep the original CA system in place throughout the home network by placing the home network between the tuner/demodulator and the CA module and a way to keep the bandwidth requirements low by intelligently filtering out data from the transport stream carried by the home network, without tampering with the CA system.

A home network has an input element receiving digital audio-video data and conditional access (CA) data from a source, and a tuner element receiving the data from the input element. In response to a demanded transport stream command, the tuner element passes only data in the demanded transport stream. This data in the demanded transport stream includes both CA data and data representing multiple audio-video programs. A first demultiplexer receives data in the demanded transport stream from the tuner element, with the first demultiplexer passing all of the CA data received from the tuner element and one and only one audio-video program in the demanded transport stream. The first demultiplexer does not pass any other audio-video program in the demanded transport stream. A conditional access (CA) device receives data from the first demultiplexer and decrypts the audio-video program in accordance with the CA data, so that a television can receive information from the CA device and display the audio-video program.

It is to be understood that when the demanded program includes two so-called “elementary” streams, e.g., a standard definition stream of the program and a high definition stream of the program, present principles can further screen out the elementary stream that is not desired.

In some embodiments, the audio-video data includes plural packets, with each packet having an unencrypted header and encrypted audio-video data. The first demultiplexer uses information in the headers, e.g., packet identification information, to determine which audio-video program to pass to the CA device. A second demultiplexer can be interposed between the CA device and television for not passing the CA data to the television.

If desired, the demanded transport stream is sent from the TV to the tuner element. The TV may access one or more tables in the MPEG stream to determine which transport stream to demand.

In another aspect, a method includes receiving a main digital transport stream that carries multiple audio video programs on respective programs. Prior to passing the programs through a conditional access (CA) device for decrypting, all audio video data of at least some of the programs is removed, and only then is the remaining audio video data passed through the CA device.

In still another aspect a TV tuner passes audio video streams of a demanded transport stream. A demultiplexer is downstream of the tuner, and a conditional access (CA) device is downstream of the demultiplexer for decrypting audio video data.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting network in accordance with present principles;

FIG. 2 is a schematic diagram of a data structure useful with the network of FIG. 1;

FIG. 3 is a flow chart of logic for reducing audio video bandwidth in the network of FIG. 1;

FIGS. 4 and 5 are block diagrams of specific non-limiting systems;

FIG. 6 is a flow chart of specific non-limiting logic for reducing audio video bandwidth; and

FIG. 7 is a block diagram of a multiple TV environment in which the present invention can be used.

### DETAILED DESCRIPTION OF THE PREFERRED EMBODIMENT

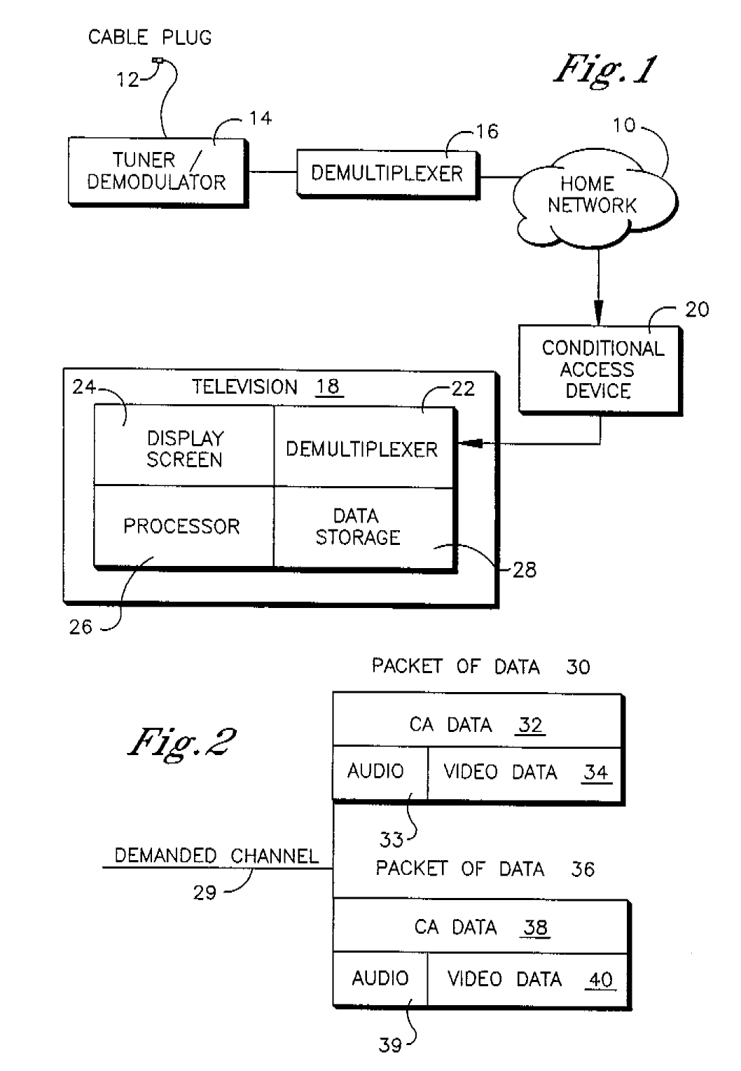

With reference to FIG. 1, a non-limiting network system is shown. The network 10 may be a home network or a non-decentralized system, and may receive a multitude of video data through an input element 12, the input element 12 possibly being a coaxial cable (satellite and/or cable and/or terrestrial distribution). Video may also be received at the input element 12 via Internet Protocol encapsulation, in which ease there is no tuner/demodulator but rather a DSL or cable modem/Ethernet card, WiFi card, etc. The input element 12 may receive digital audio-video data and conditional access (CA) data from a source.

The input element 12 is electronically connected to a stream selector assembly 14. The assembly 14 receives plural streams and selects one stream as demanded for output thereof to the below-discussed demultiplexer. In a non-limiting implementation the assembly 14 may be a tuner/demodulator assembly, which includes separate components that may be combined on a single integrated circuit in series with each other. In another embodiment the assembly 14 may be implemented as a network interface card. In any case, the assembly 14 receives data from the input element 12 and, in response to a demanded program command from a user separates as required the transport stream carrying the requested program from other transport streams received at the input element 12. Accordingly, the assembly 14 passes through only data of one transport stream.

The data received through the assembly 14 eventually must be carried over to the below-described CA module. This data is organized in Transport Stream Packets. If the packet is scrambled and belongs to the selected program it is descrambled and received back from the module providing access to the service is granted. The same applies if the packet is scrambled at the at Packetized Elementary Stream (PES) level. If the packet does not belong to the selected program it is passed through untouched.

As non-limiting examples, audio packets of unrequested programs that are not shared with the requested program are blocked. Thus, for instance, if a program has a high definition video elementary stream and standard definition video elementary stream which share a single audio stream, and the high definition elementary stream of the program is requested, then the shared audio stream is also passed along with the requested high definition video stream of the requested program, with both the standard definition video elementary stream and audio packets not associated with the requested stream being blocked. As well, audio, video and other packets that are identified not to disrupt the CA module and that are associated with unrequested programs are not passed to the CA module. For example, computer applications and other ancillary in the multiplex that are not related to the requested program also can be blocked from processing by the CA module.

Thus, a conditional access module 20, which may be implemented as a cable card device, decrypts the multimedia data belonging to the requested program that it receives. Absent the present invention, the MPEG-2 Transport Stream sent to the CA module consists of the whole MPEG-2 multiplex. This means that the packet sent over may belong to the selected program but may also belong to another program that is not currently selected but nonetheless carried within the same Transport Stream multiplex. This results in an excess in bandwidth usage along the path between the tuner/demodulator and the CA module.

The CA system relies on secret messages being buried within transport packets carried within this Transport Stream multiplex and prevents the identification of these packets as part of its robustness. But although the CA system prevents direct identification of these secret messages, one can postulate that for implementation cost and feasibility of the CA system and other head end equipment the CA system doesn't rely on the audio/video packets that belong to other programs carried over the transport stream. This critical recognition of the present invention forms the basis for a method to decrease the data flow from the tuner/demodulator to the CA module.

With this in mind and to reduce bandwidth, in the present invention the first demultiplexer element 16 is in the path between the stream selector 14 and the CA module element 20. This demultiplexer element 16 intercepts the transport stream and selectively filters out some packets before forwarding the remaining packets of the transport stream to the CA module. In one implementation this first demultiplexer passes all of the data received from the stream selector assembly 14 except the audio-video packets belonging to programs other than the demanded program.

Disclosure below describes the determination of which audio-video data packets should be passed and which other data packets may be discarded based on the postulate that the CA data is not embedded in the audio video packets of other program channels. As discussed further below in specific implementations, information in the service information (“SI”) data is used to configure the demultiplexer 16 to determine which identifiable packets were not explicitly requested and thus should not be passed on to the conditional access device 20. Consequently, the only audio-video data stream remaining present in the selected transport stream going from the first demultiplexer element 16 to the conditional access device 20 belongs to the selected program.

In another implementation the first demultiplexer 16 passes all of the data received from the assembly 14 except all the packets belonging only to programs other than the demanded program. Advantageously, fewer data is passed to the conditional access device 20 resulting in a reduced consumption of bandwidth, allowing a simpler connector or even a complete home network environment 10 to be used to transport data from the stream selector assembly 14 to the CA module.

The conditional access device 20 is electronically connected to a second demultiplexer 22, the demultiplexer 22 being interposed between the conditional access device 20 and a video processing device, such as a set-top box, a computer with a video player, and a television 18. The second demultiplexer 22 sends the desired audio-video data packet to the television 18 but further excludes the unnecessary data contained within the receiver transport stream. The demultiplexer 22 thus allows only necessary audio-video data to be sent to the audio-video decoder of the television.

Further, the television 18 includes a screen 24 which produces electronic images, a processor 26 and an optional data storage 28. The television 18 thus receives information from the conditional access device 20 and displays the audio-video program on the screen 24.

It is to be understood that the components shown in FIG. 1 may be housed in a single TV chassis, or one or more of them may be housed separately from each other. It is to be further understood that control lines from the processor to various components have been omitted for clarity in one or more of the figures.

Now referencing FIG. 2 for an understanding of the data structure that can be exploited using present principles, alternate packets of audio-video data on different programs that are contained within one demanded transport stream 29 are shown. The packet of data 30 indicates the structure of incoming data packets being received by the home network 10. The packets of data 30 contain CA data 32 and audio data 33 and/or video data 34 (audio data typically are carried in packets different from individual video packets, with the packets together establishing an audio-video stream).

FIG. 2 shows other packets of data 36, which contain different CA data 38 and audio data 39 and/or video data 40. While only two packets of data on different programs is shown in FIG. 2, it is generally understood that non-limiting plural packets of data with substantially similar data structures may be contained on one demanded transport stream. Also, not all audio and video streams need be encrypted. It is possible to have an encrypted program transported with an unencrypted program. As well, data types other than audio, video, and CA may be transported.

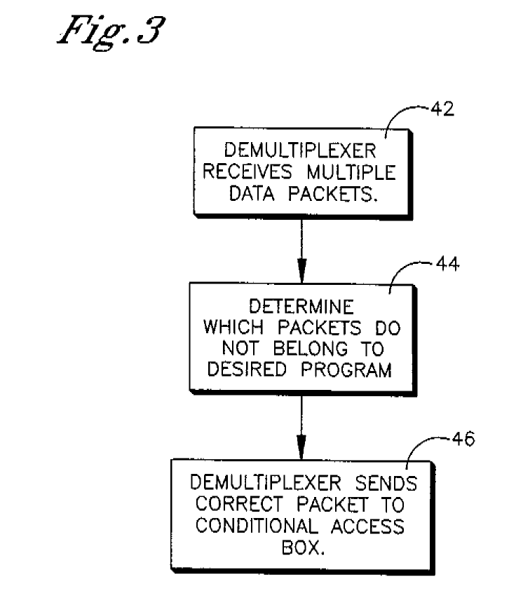

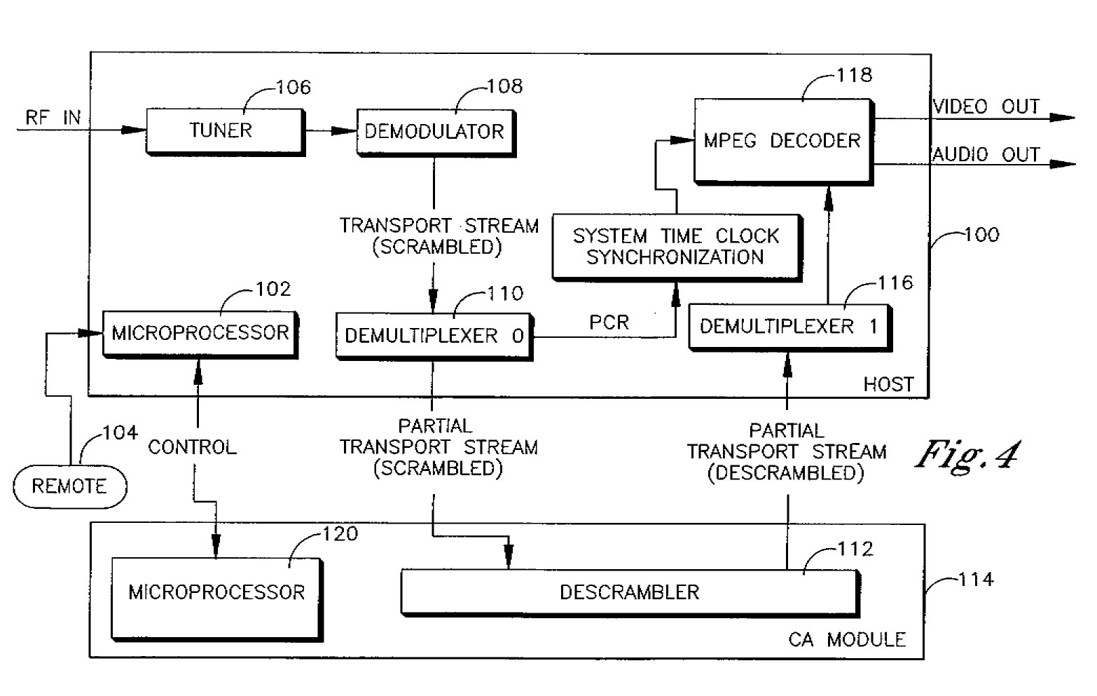

Moving to FIG. 3, logic is shown that is embodied by the operation of the first demultiplexer 16 to determine which audio-video packet should not be sent to the conditional access device 20. While the demultiplexer 16 embodies the logic in the non-limiting implementation shown, it is to be understood that alternatively, the logic could be undertaken by a digital processor in, e.g., a set-top box executing instructions on a computer readable storage medium such as a solid state memory, disk-based memory, or other memory device.

Beginning with block 42, the demultiplexer 16 receives plural audio-video packets belonging to different programs. At block 44 the logic determines which audio-video packets do not belong to the requested program and hence should be removed from the transport stream that is forwarded to the conditional access device 20. The undesired packets are selected by the demultiplexer 16 based on the accompanying program specific information (PSI) data in MPEG as is contained primarily in the program allocation table (PAT) and program map tables (PMT) 32. Concluding the logic at block 46, the remaining packets are sent to the conditional access device 20.

FIGS. 4-6 show detailed non-limiting examples of the above principles. FIG. 4 illustrates a detailed non-limiting example of the above principles that reduces the bandwidth on the connectors carrying the partial transport streams between a host and the CA module. In this system, a host 100 such as a TV or set-top box has a host processor 102 that can receive wireless command signals from a remote control device 104 to control, e.g., which TV transport stream is tuned to by a timer 106 which receives TV signals in the form of, e.g., radiofrequency (RF) signals as shown. These signals may be demodulated by a demodulator 108, which outputs a scrambled transport stream to a first demultiplexer 110. In accordance with principles above, the first demultiplexer 110 sends only a partial scrambled transport stream, i.e., a stream carrying audio/video packets of only the desired digital program, to a descrambler 112 of a conditional access (CA) module 114, without a home network interposed therebetween in this particular non-limiting example. The descrambler 112 operates on the stream to return the partial transport stream with descrambled packets that belong to the selected program to a second demultiplexer 116 in the host 100, which selects the desired audio-video data packets from the stream and sends the stream to a video decoder 118 for outputting video and audio for display on a monitor and speakers. Control information may be exchanged between the host processor 102 and a module processor 120 of the CA module 114 as shown.

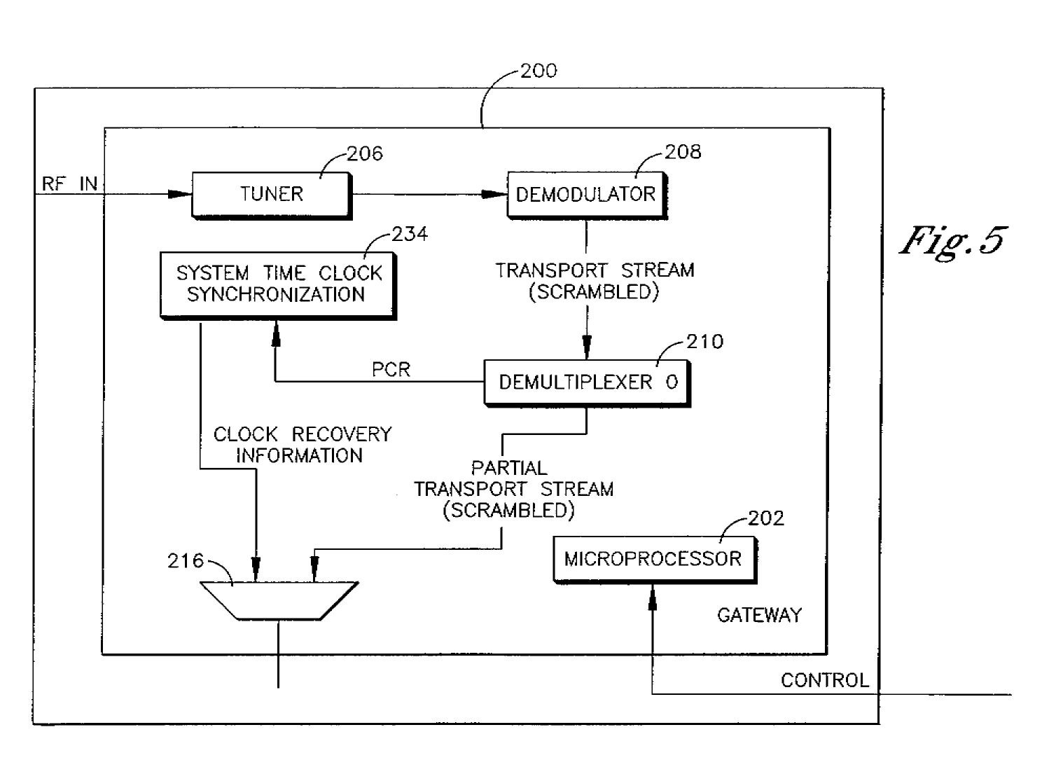

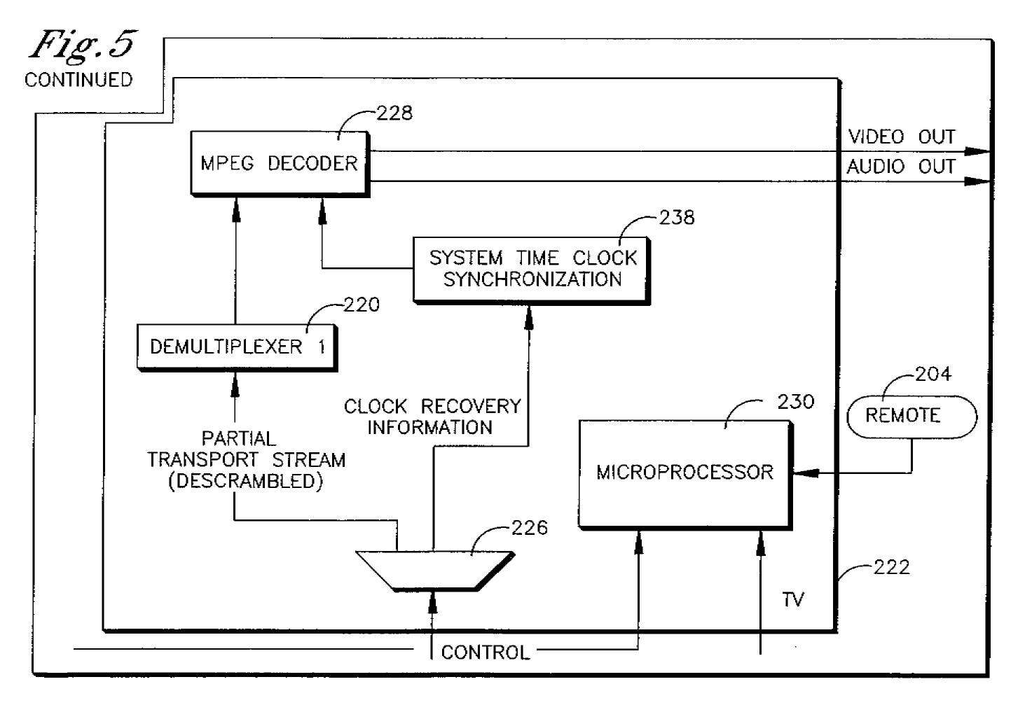

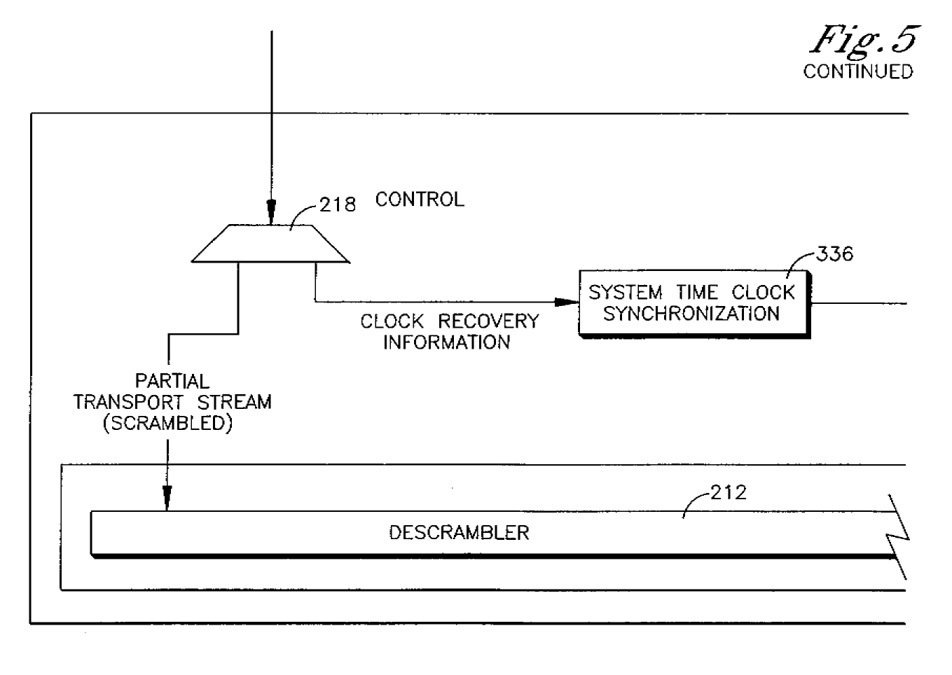

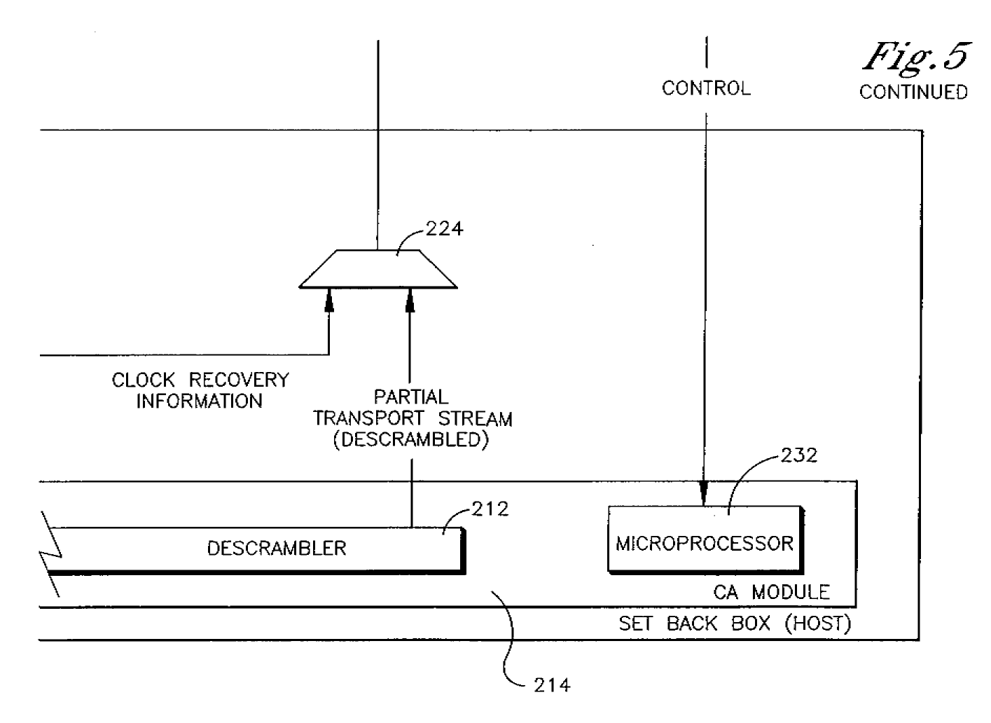

FIG. 5 illustrates a detailed non-limiting example of the above principles that reduces the bandwidth requirements of the home network connection placed between the gateway and the CA module which can be mounted on or built in to the TV. In this alternate system, a gateway 200 circuit has a gateway processor 202 that can receive wireless command signals from a remote TV device 222 to control, e.g., which TV transport stream is tuned to by a tuner 206 which receives TV signals in the form of, e.g., radiofrequency (RF) signals as shown. These signals may be demodulated by a demodulator 208, which outputs a scrambled transport stream to a first demultiplexer 210. In accordance with principles above, the first demultiplexer 210 sends only a partial scrambled transport stream, i.e., a stream carrying audio/video packets of only the desired digital program, to a descrambler 212 of a conditional access (CA) module 214 through respective gateway and module scrambled combining components 216, 218. The descrambler 212 operates on the stream to return the partial transport stream with the descrambled packets that belong to the selected program to a second demultiplexer 220 in a TV 222 through respective module and TV unscrambled combining components 224, 226, which selects the desired audio-video data packets from the stream and sends the stream to a video decoder 228 for outputting video and audio for display on a monitor and speakers. Control information may be exchanged between the gateway processor 202, a TV processor 230, and a module processor 232 of the CA module 214 as shown.

Each of the three major components (the gateway 200, the CA module 214, which may be embodied in a set back box or set top box, and the TV 222) has a respective system time clock synchronization circuit 234, 236, 238, which may be implemented by or include counters. The gateway clock synchronization circuit 234 can receive program clock reference (PCR) information from the first demultiplexer 210 and return clock recovery information to the module clock synchronization circuit 236 as shown. In turn, this clock recovery information may be sent from the module clock synchronization circuit 236 to the TV clock synchronization circuit 238 as shown. The clock recovery information may be used to synchronize the clocks of the various components.

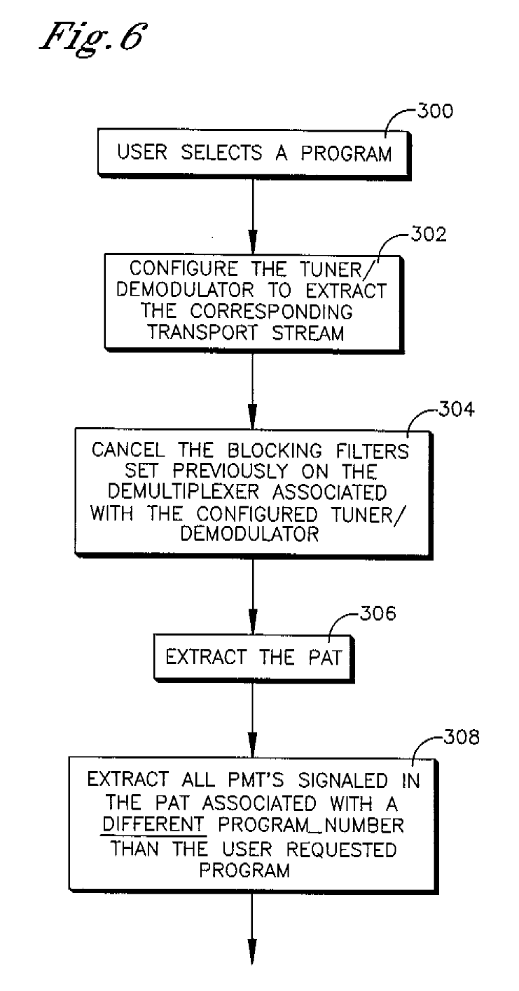

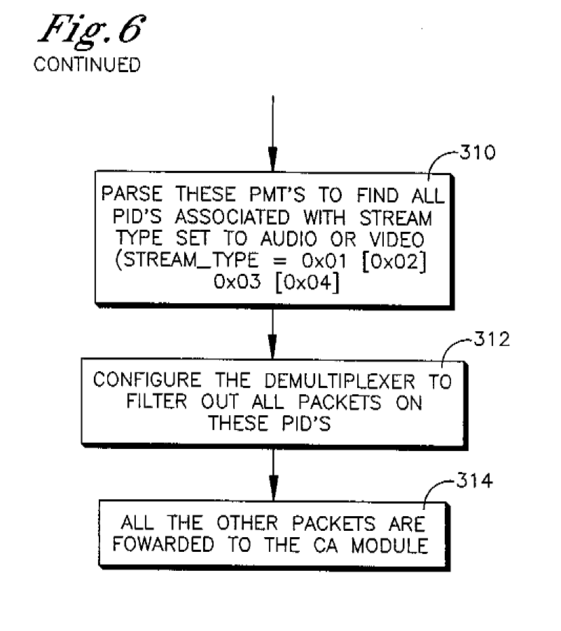

Turning now to FIG. 6 for logic that may be implemented by any one of the above systems and more particularly by any appropriate one of the above processors acting in concert with the demultiplexers, commencing at block 300 a user can select a program to view by, e.g., manipulating one of the remote control devices disclosed above. In response, at block 302 the tuner and demodulator of the system are caused (by, e.g., a TV processor or SBB processor) to tune to the desired and to extract the associated transport stream. At block 304, any blocking filters (discussed further below) on the first demultiplexer, e.g., the demultiplexer 110 of FIG. 4 or the demultiplexer 210 of FIG. 5, that may have been set for the previous program are canceled.

Next, the program allocation table (PAT) in the received stream is extracted and processed at block 306 by, e.g., the host processor 102 in FIG. 4. Proceeding to block 308, all program map tables (PMT) signaled in the PAT that are associated with programs other than the one requested at block 300 are extracted and at block 310 parsed to identify packet identifications (PID) associated with audio and video packets in the non-requested programs. At block 312 the first demultiplexer, e.g., the demultiplexer 110 of FIG. 4 or the demultiplexer 210 of FIG. 5, is configured to filter out all packets having the PIDs identified in block 310. This configuration may be undertaken by setting appropriate blocking filters in the demultiplexer. All other packets (including the audio and video packets associated with the requested program) are forwarded to the CA module for descrambling at block 314.

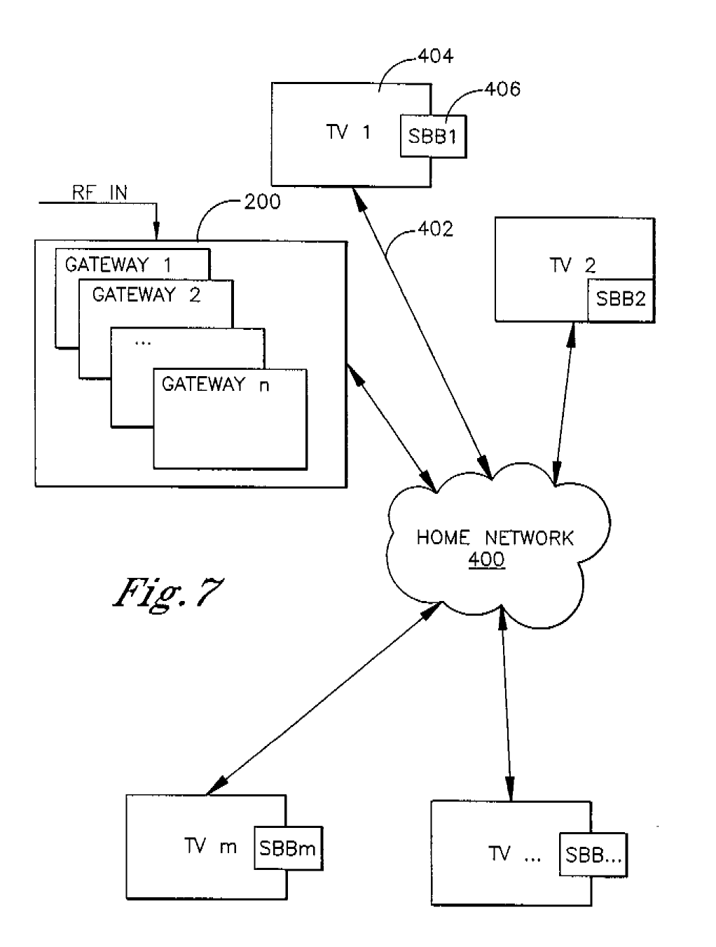

FIG. 7 shows that multiple gateways 200 shown in, e.g., FIG. 5 and described above can communicate with a home network 400 for sending respective partial transport streams with scrambled packets 402 to respective TVs 404, each potentially with its own set-back box (SBB) 406.

While the particular SYSTEM AND METHOD FOR REDUCING scrambled and descrambled BANDWIDTH IN A HOME NETWORK is herein shown and described in detail, it is to be understood that the subject matter which is encompassed by the present invention is limited only by the claims.

What is claimed is:

1. A home network, comprising:
an input element receiving data including digital audio-video data and conditional access (CA) data from a source;
a tuner element receiving the data from the input element and in response to a demanded transport stream command, passing only data in the demanded transport stream, the data in the demanded transport stream including CA data and data representing at least two audio-video programs;
a first demultiplexer receiving data in the demanded transport stream from the tuner element, the first demultiplexer passing all of the CA data received from the tuner element and one and only one audio-video program in the demanded transport stream, the first demultiplexer not passing any other audio-video program in the demanded transport stream;
a conditional access (CA) device receiving data from the first demultiplexer and decrypting the audio-video program; and
a television receiving information from the CA device and displaying the audio-video program.

2. The network of claim 1 wherein the audio-video data includes plural packets, each packet having an unencrypted header and audio-video data, the first demultiplexer using information in the headers to determine which audio-video program not to pass to the CA device.

3. The network of claim 2, comprising a second demultiplexer interposed between the CA device and a television display for not passing the CA data to the television.

4. The network of claim 1, wherein the CA device is a CA cable card.

5. The network of claim 2, wherein the information in the headers used to determine which audio-video program to block from the CA device is packet identification (PID) information.

6. The network of claim 1, wherein one or more tables in the MPEG stream are accessed to determine which transport stream to block.

7. A method, comprising:
receiving at least one main digital transport stream, the main digital transport stream carrying plural audio video programs on respective programs;
prior to passing the programs through a conditional access (CA) device for decrypting, removing all audio video data of at least some of the programs; then
passing remaining audio video data through the CA device.

8. The method of claim 7, wherein audio video data of all but one of the programs is removed, and only the audio video data of the one of the programs is sent to the CA device.

9. The method of claim 8, wherein no non-audio video data in the main digital transport stream is removed prior to sending data to the CA device.

10. The method of claim 9, wherein the audio video data of all but one of the programs is removed by a demultiplexer.

11. The method of claim 10, wherein the non-audio video data in the main digital transport stream is removed by a demultiplexer after being sent to the CA device.

12. The method of claim 7, wherein the audio-video data includes plural packets, each packet having an unencrypted header and audio-video data, information in the headers being used to determine which audio-video program to pass to the CA device.

13. The method of claim 7, wherein the CA device is a CA cable card.

14. The method of claim 12, wherein the information in the headers used to determine which audio-video program to pass to the CA device is packet identification (PID) information.

15. A system, comprising:
a TV tuner passing audio video streams of a demanded transport stream;
a demultiplexer downstream of the tuner; and
a conditional access (CA) device downstream of the demultiplexer and decrypting audio video data.

16. The system of claim 15, comprising:
an input element receiving the audio-video data and conditional access (CA) data from a source;
the tuner receiving the data from the input element and in response to a demanded transport stream command, passing only data in the demanded transport stream, the data in the demanded transport stream including CA data and data representing at least two audio-video programs;
the demultiplexer being a first demultiplexer and receiving data in the demanded transport stream from the tuner, the first demultiplexer passing all of the CA data received from the tuner and one and only one audio-video program in the demanded transport stream, the first demultiplexer not passing any other audio-video program in the demanded transport stream;
the CA device receiving data from the first demultiplexer and decrypting the audio-video program in accordance with at least some of the CA data; and
a television receiving information from the CA device and displaying the audio-video program.

17. The system of claim 16, wherein the audio-video data includes plural packets, each packet having an unencrypted header and audio-video data, the first demultiplexer using information in the headers to determine which audio-video program to pass to the CA device.

18. The system of claim 17, comprising a second demultiplexer interposed between the CA device and television for not passing the CA data to the television.

19. The system of claim 17, wherein the information in the headers used to determine which audio-video program to pass to the CA device is packet identification (PID) information.

20. The system of claim 16, wherein the demanded transport stream is sent from the TV to the tuner, the TV accessing one or more tables in the MPEG stream to determine which transport stream to demand.

21. A component assembly, comprising:
a transport stream selector element passing packets from a demanded transport stream to a packet filter;
the packet filter receiving transport stream packets from the transport stream selector with an unencrypted header, the filter blocking at least some packets identified to carry video and/or audio data for an non-requested program and passing remaining packets to a Conditional Access device;
the conditional access (CA) device receiving packets from the packet filter and decrypting the audio-video program; and
a video and/or audio processing device receiving packets from the CA device and processing the requested audio-video program.
